(19) United States
(12) Patent Application Publication
(10) Pub. No.: US 2014/0180874 A1
(43) Pub. Date: Jun. 26, 2014

(54) LOCAL PRODUCT COMPARISON SYSTEM

(71) Applicant: Lucy Ma Zhao, Austin, TX (US)

(72) Inventor: Lucy Ma Zhao, Austin, TX (US)

(21) Appl. No.: 13/725,307

(22) Filed: Dec. 21, 2012

(51) Int. Cl. G06Q 30/06

(52) U.S. Cl. CPC G06Q 30/0623
USPC 705/26.61

(57) ABSTRACT

Systems and methods for providing local product comparison include receiving an image that includes a first product from an image capturing device and receiving location information associated with a location of the first product from a location determination device. First product identification information is retrieved using the image. The first product identification information identifies at least a type of the first product. First product purchase history information about the first product and second product purchase history information about a second product that is associated with the location are retrieved using the first product identification information and the location information. The first product purchase history information and the second product purchase history information are then provided for display on a display device. The first product purchase history and the second product purchase history may be provided for display on the display device as a graphical comparison.

### BACKGROUND

1. Field of the Invention

The present invention generally relates to payments and more particularly to a local product comparison system that may be used in making mobile or conventional payments

2. Related Art

More and more consumers are purchasing items and services over electronic networks such as, for example, local area networks (LANs) or the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Consumers today are confronted with a wide variety of brands that offer the same type of product. For example, in a given location (e.g., a physical/“brick and mortar” store) a consumer shopping for bread, wine, shoes, and/or a wide variety of other products known in the art may be confronted with a very large number of different brands offering the same types of product. Thus, when making the decision on which brand of the product to purchase, the consumer may be confused or overwhelmed with all their different choices and end up just purchasing the first brand product they come across, comparing the different brands of product based on packaging or marketing, or otherwise not making the most informed decision on the brand of product they choose to purchase.

Thus, there is a need for an improved product purchase determination system.

### BRIEF DESCRIPTION OF THE FIGURES

FIG. 1 is a flow chart illustrating an embodiment of a method for providing a local product comparison.

FIG. 2 is a front view illustrating an embodiment of a user device displaying a product comparison start screen;

FIG. 3a is a perspective view illustrating a user capturing an image of a product;

FIG. 3b is a is a front view illustrating an embodiment of a user device displaying the image of the product captured as illustrated in FIG. 3a;

FIG. 4 is a is a front view illustrating an embodiment of a user device displaying a product comparison screen;

FIG. 5 is a is a front view illustrating an embodiment of a user device displaying a product review screen;

FIG. 6 is a schematic view illustrating an embodiment of a networked system;

FIG. 7 is a perspective view illustrating an embodiment of a user device;

FIG. 8 is a schematic view illustrating an embodiment of a computer system; and

FIG. 9 is a schematic view illustrating an embodiment of a user device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for providing a local product comparison. As discussed below, in some embodiments, a user of the systems or methods of the present disclosure may enter a physical location where products are offered for sale such as a grocery store, a clothing store, a convenience store, and/or a variety other physical locations known in the art where products are offered for sale, and capture information about a first product they are interested in purchasing. Capturing the information about the first product may be accomplished by capturing an image of the first brand of product using a user device, scanning a product code of the first product using the user device, describing the first product via text input or audio input to a user device, and/or using a variety of other methods known in the art. The captured information about the first product is then used to retrieve identification information about that first product. A location of the first product is also determined using, for example, a location determination device in the user device. The location information and the identification information about the first product are then used to retrieve a purchase history of the first product at the physical location, along with purchase histories of one or more other products that are similar to the first product. The purchase histories of each of the first product and the one or more other products may then be displayed on the user device and used by the user to determine which of the first product and the one or more other products to purchase. Other product information about the first product and the one or more other products such as, for example, product reviews, may be retrieved and displayed on the user device in order to further assist the user in making the purchasing decision.

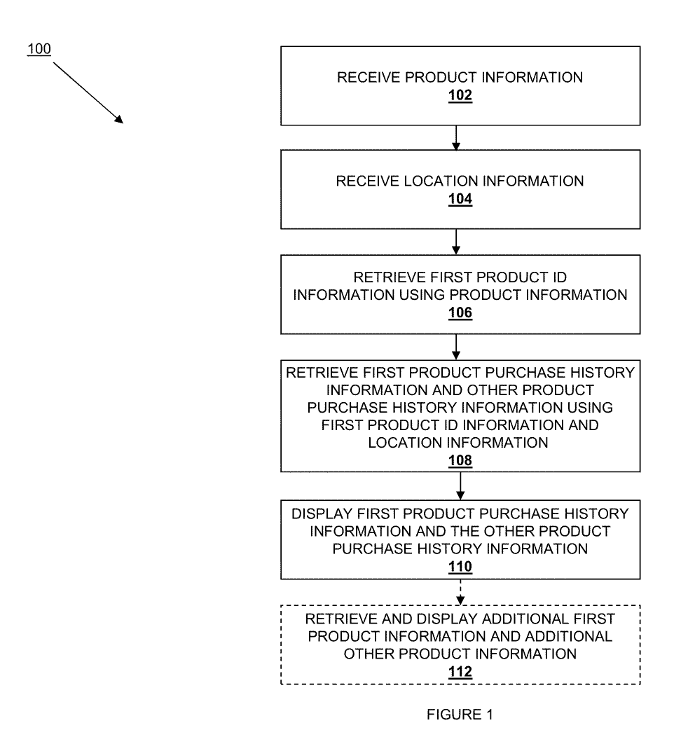

Referring now to FIGS. 1, 2, 3a, and 3b, a method 100 for providing local product comparisons is illustrated. In an embodiment of the method 100 described below, an account provider may provide a user with one or more payment accounts, and the user may use the payment accounts to fund payments for purchases made from merchants. For example, the user may be provided with a credit account, a debit account, a savings account, and/or a variety of other payments accounts known in the art. In another embodiment, a payment service provider such as, for example, PayPal, Inc. of San Jose, Calif., assists in the making of payments from the user to the merchant by transferring funds from the payment account of the user to a merchant account of the merchant. Any of the merchant, account providers, payment service providers, and/or other system provider may assist in offering engines, databases, and/or other systems for providing the local product comparison method discussed below. However, the embodiments discussed below are meant to be merely exemplary, and one of skill in the art will recognize that a variety of modifications may be made to the local product comparison system discussed below without departing from the scope of the present disclosure.

The method 100 begins at block 102 where product information is received. As discussed in further detail below, in some embodiments, the method 100 is performed by a mobile user device of a user such as a phone or other portable device. As is known in the art, the user may carry their mobile user device to a variety of different physical locations where products are offered for sale. While the illustrated embodiment below depicts a shoe store where a variety of types, styles, and brands of shoes are sold, the present disclosure is not limited to the type of product or products that are compared. For example, an alcohol store that sells a wide variety of alcoholic drinks (e.g., beer, wine, liquor, etc.), a grocery store that sells a wide variety of food (e.g., bread, cereal, hot sauces, etc.) or other goods (e.g., shampoo, make-up, cleaning products), a department store that sells a wide variety of clothing (e.g., dresses, shirts, pants, etc.), and/or any other physical location where any other products are offered for sale are envisioned as falling within the scope of the present disclosure. Thus, the examples below should not be read to limit the systems and methods of the present disclosure to any particular products.

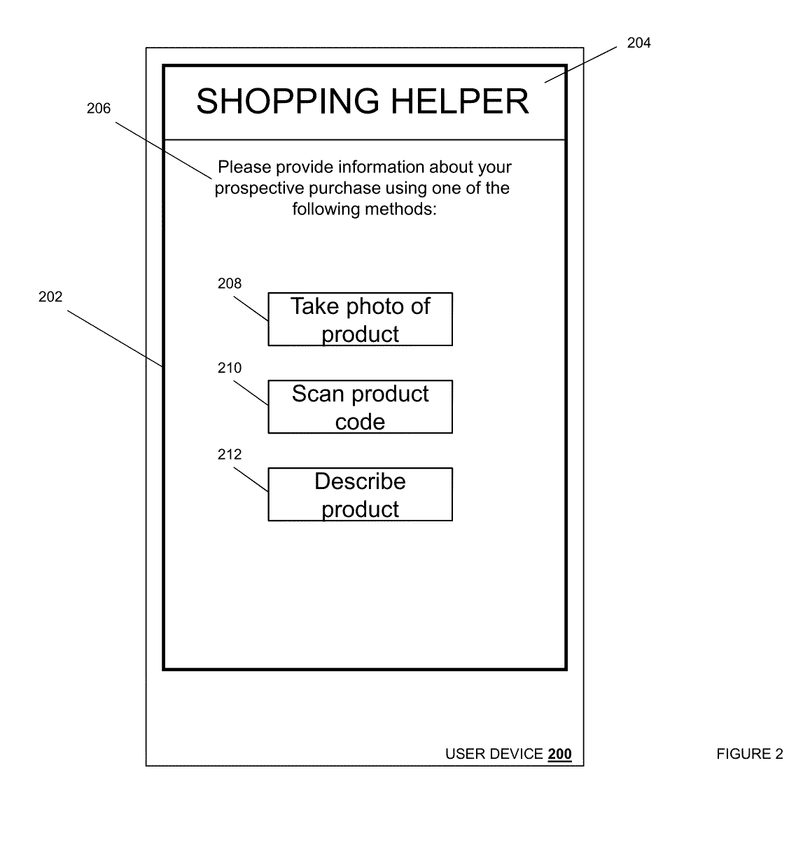

FIG. 2 illustrates an embodiment of a user device 200 used in the method 100. In the embodiments discussed below, the user device 200 is described as a mobile phone, but one of skill in the art will recognize that the user device 200 may be any portable computing device known in the art that provides the functionality discussed below. The user device 200 of the illustrated embodiment includes a display device 202.

Referring now to FIGS. 1, 2, and 3a, the method 100 may begin at a physical location 300 that includes a plurality of products 302. In the illustrated embodiment, the physical location 300 is a shoe store with the plurality of products 302a, 302b, 302c, 302d, etc., that include a plurality of different types, styles, brands, and/or other characteristics of shoes. However, as discussed above, examples of other products (wine and bread) in other physical locations (wine stores and grocery stores, respectively) will be described below to illustrate the wide variety of products and physical locations that will fall within the scope of the present disclosure. At block 102 of the method 100, a user 304 having the user device 200 enters the physical location 300 and is confronted with the plurality of products 302a, 302b, 302c, 302d, etc. As is known in the art, the user 304 may select one of the plurality of products 302a, 302b, 302c, 302d, etc. that the user 304 may be interested in purchasing (e.g., in the embodiment discussed below, the user 304 is interested in a particular brand and style of high heeled shoe). However, the user 304 may also be interested in some of the other products 302a, 302b, 302c, 302d, etc. as well. For example, the user 304 may be interested in other types of the products 302a, 302b, 302c, 302d, etc. (e.g., the user may be interested in tennis shoes, boots, sandals, and/or shoes types other than high heeled shoes), in other brands of the same type of product (e.g., the user may be interested in different brands/designers of high heeled shoes), in other styles of the same type of product (e.g., the user may be interested in formal high heeled shoes, casual high heeled shoes, different heel sizes of high heeled shoes, and/or a variety of other shoes styles known in the art.)

Given the selection by the user 304 of the one of the plurality of products 302a, 302b, 302c, 302d, etc. that the user 304 is interested in purchasing, while also considering the other products 302a, 302b, 302c, 302d, etc. that the user 304 may also be interested in, the user 304 may operate the user device 200 to cause the user device 304 to display a local product comparison start page 204 that will allow the user 304 to quickly and easily compare some of the products 302a, 302b, 302c, 302d available for purchase at the physical location 300. In an embodiment, the user device 200 may include software that is located on a non-transitory, computer-readable medium that, when executed by one or more hardware processors in the user device 200, cause the one or more hardware processors to execute a local product comparison application that will display the local product comparison start page 204. In an embodiment, the local product comparison application may be available from a system provider such as, for example, PayPal, Inc. of San Jose, Calif., and may perform other operations than those discussed herein (e.g., the local product comparison application may be part of a payment services application that allows for mobile payments and payment processing using the user device 200.) However, the local product comparison application may be provided by a variety of other system providers known in the art and may operate alone or with a variety of other application functionality without departing from the scope of the present disclosure.

In the embodiment illustrated in FIG. 2, the local product comparison start screen 204 includes a product information request 206 that requests that the user 304 provide information about the product that the user 304 is interested in purchasing. As illustrated, the user 304 may use the user device 200 to provide the product information at block 102 of the method 100 in a variety of ways. In the illustrated embodiment, the local product comparison start screen 204 provides an image capture selector 208 that the user 304 may select (e.g., via a touch screen function through the display device 202) in order to activate an image capturing device in the user device 200 for use in capturing an image of the product or product information. For example, selection of the image capture selector 208 may activate a camera in the user device 200 so that the user 304 may capture an image of a product (as illustrated in the embodiment discussed below), to capture an image of product information (e.g., capture an image of a Universal Product Code (UPC) on the product, capture an image of a Quick Response (QR) code on the product, and/or capture images of a variety of other product information known in the art), and/or capture an image of a variety of other product identifying details known in the art.

In the illustrated embodiment, the local product comparison start screen 204 also provides a scan product code selector 210 that the user 304 may select (e.g., via a touch screen function through the display device 202) in order to activate an scanning device in the user device 200 for use in capturing information on a product code associated with a product. For example, selection of the scan product code selector 210 may activate a laser scanner in the user device 200 so that the user 304 may capture product information (e.g., capture information included in a Universal Product Code (UPC) on the product and/or capture information included in a variety of other product codes known in the art).

In the illustrated embodiment, the local product comparison start screen 204 also provides a describe product selector 212 that the user 304 may select (e.g., via a touch screen function through the display device 202) in order to activate product description input device in the user device 200 for use in capturing a description of a product provided by the user 304. For example, selection of the describe product selector 212 may activate a text input system in the user device 200 so that the user 304 may provide text describing the product, activate a voice recognition system in the user device 200 so that the user may speak into a microphone on the user device 200 to describe the product, and/or activate a variety of other user-provided description capturing systems known in the art.

Thus, at block 102 of the method 100, the user device 200 receives product information from the user 304 about the product that the user 304 is interested in purchasing. While a few examples of the provision of product information using a user device at block 102 of the method 100 have been described, one of skill in the art will recognize that a variety of product information provision systems will fall within the scope of the present disclosure.

The method 100 then proceeds to block 104 where location information is received. In an embodiment, a location determination device such as, for example, a Global Positioning System (GPS) in the user device 200, a cell tower triangulation device in the user device 200, and/or a variety of location determination devices known in the art may be used to determine location information associated with the physical location 300 (i.e., the current location of the user device 200.) In another embodiment, the user 304 may be prompted to provide location information about the physical location 300, including a prompt for the user 304 to allow a location determination device in the user device 200 to determine the location information associated with the physical location 300, a prompt and input that allowed the user to enter (e.g., via a text input system on the user device 200, via speaking into a microphone on the user device 200 and the use of a voice recognition system, etc.) the location information into the user device 200, and/or a variety of other location information retrieval techniques known in the art. In an embodiment, block 104 may be performed at substantially the same time as block 102 of the method 100. For example, the provision of the product information at block 102 may result in the automatic determination (e.g., by a location determination device in the user device 200) of the location information, or may include the prompting of and provision by the user of the location information.

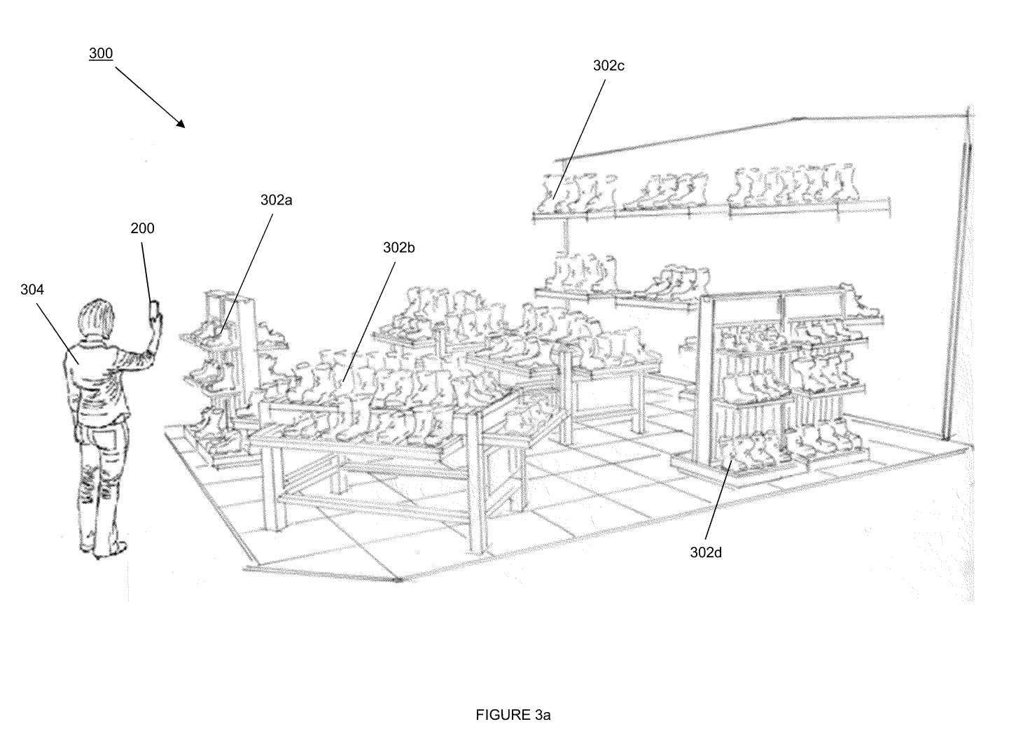

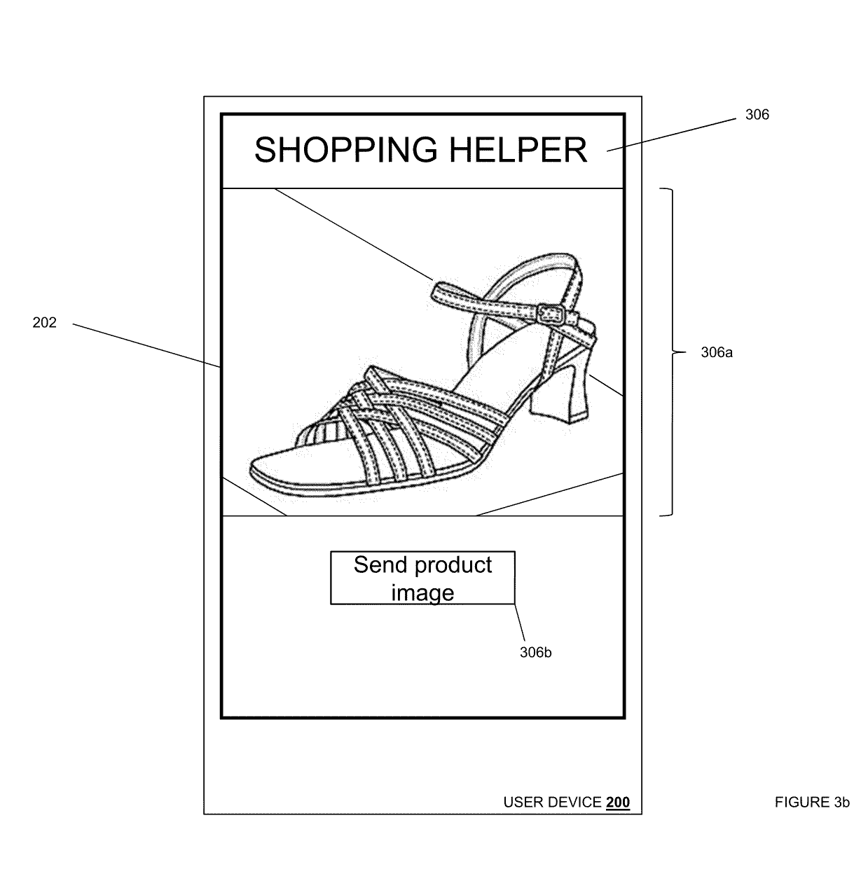

Referring now to FIGS. 1, 3a and 3b, the method 100 then proceeds to block 106 where first product identification information is retrieved using the product information. In some embodiments, the product information received in block 102 may be explicitly included the first product identification information (e.g., the product information received in block 102 may include a product code or description that includes the first product identification information), and thus the retrieval of the first product identification information may include the user device 200 determining that the first product identification information is included in the product information received at block 102. In other embodiments, the product information received at block 102 may need to be processed to determine the first product identification information (e.g., the product information may be an image of the product, an image of a product code, a description of the product that does not include the first product identification information, etc.), used as a reference to look up the first product identification information, and/or otherwise used in a manner to retrieve the first product identification information when that first product identification information is not explicitly included in the product information received at block 102. A few examples of the retrieval of first product identification information using the product information received in block 102 are provided below, but one of skill in the art will recognize that a variety of first product identification information retrieval methods will fall within the scope of the present disclosure.

As discussed above, the product information received in block 102 may explicitly include the first product identification information. For example, the user 304 may have used a scanning device to scan a product code associated with the product that the user 304 is interested in purchasing at block 102, and that scanning may result in the product information being received at block 102 that includes the first product identification information that identifies the product (e.g., a product identification number used at the physical location 300 to identify the product.) In another example, the user 304 may have used a text input system or a voice recognition system to provide a description of a product code associated with the product that the user 304 is interested in purchasing at block 102, and that description may result in the product information being received at block 102 that includes the first product identification information that identifies the product (e.g., a product identification number used at the physical location 300 to identify the product.)

As also discussed above, the product information received at block 102 may need to be processed to determine the first product identification information. In an embodiment, the user 304 may have used an image capturing device on the user device 200 to capture an image that includes the product that the user 304 is interested in purchasing. For example, FIG. 3b illustrates the user device 200 displaying an image display screen 306 that includes an image 306a taken using a camera in the user device 200. As can be seen, the image 306a in the illustrated embodiment includes the shoes that the user 304 is interested in purchasing.

At block 106, the image 306a may be used in a variety of manners to retrieve the first product identification information. For example, the user device 200 may include an image recognition engine (e.g., stored as instruction on a memory that are executable by a processor to cause the processor to perform the functions of the image recognition engine) that processes the image 306a and that is operable to determine details about the product included in the image including, for example, a type of the product, a brand of the product, a style of the product, and/or a variety of other product characteristics known in the art that are displayed in the image 306a. The user device 200 may then use the details about the product determined using the image recognition techniques to retrieve the first product identification information from a product database.

In another example, the user device 200 may send the image 306a over a network (e.g., the Internet, a local area network (LAN), and/or a variety of other networks known in the art) to an image recognition device that includes an image recognition engine that processes the image 306a and that is operable to determine details about the product included in the image including, for example, a type of the product, a brand of the product, a style of the product, and/or a variety of other product characteristics known in the art that are displayed in the image 306a. The image recognition device may then use the details about the product determined using the image recognition techniques to retrieve the first product identification information from a product database, and then send that first product identification information back over the network to the user device 200.

In an embodiment, the product database may be included in the user device 200, the image recognition device, a product database device that is at the physical location 300 (e.g., a server in the shoe store that stores inventory and/or sales information about the shoes for sale at the store), and/or another device coupled to the network. In the illustrated embodiment, the image display screen 306 includes a send product image selector 306b that may be selected by the user 304 to send the image 306a over the network for processing. However, in other embodiments, upon being captured, the image 306a may automatically be sent over the network for processing without any further input from the user 304.

In another example, the user device 200 may include an product code decoder engine (e.g., stored as instruction on a memory that are executable by a processor to cause the processor to perform the functions of the product code decoder engine) that processes the image 306a and is operable to decode a product code (e.g., a UPC, a QR code, and/or a variety of other product codes known in the art) to retrieve the first product identification information.

In another example, the user device 200 may send the image 306a over a network (e.g., the Internet, a local area network (LAN), and/or a variety of other networks known in the art) to an product code decoder device that includes an product code decoder engine that processes the image 306a and is operable to decode a product code (e.g., a UPC, a QR code, and/or a variety of other product codes known in the art) to retrieve the first product identification information. The product code decoder device may then send that first product identification information back over the network to the user device 200.

In another example, the user device 200 may include a description interpretation engine (e.g., stored as instruction on a memory that are executable by a processor to cause the processor to perform the functions of the description interpretation engine) that processes a product description provided by the user 304 (e.g., via a text input system on the user device 200, a voice recognition system on the user device, etc.) and is operable to determine the first product identification information from the product description.

In another example, the user device 200 may send a product description provided by the user 304 over a network (e.g., the Internet, a local area network (LAN), and/or a variety of other networks known in the art) to an description interpretation device that includes a description interpretation engine that processes the product description provided by the user 304 (e.g., via a text input system on the user device 200, a voice recognition system on the user device, etc.) and is operable to determine the first product identification information from the product description. The description interpretation device may then send that first product identification information back over the network to the user device 200.

The first product identification information retrieved at block 106 of the method 100 may include a variety of identification information that may be used to identify the product that the user 304 is interested in purchasing. For example, the first product identification information may include any identifier that is used to track the purchases of a type of a product, a brand of a product, a style of a product, and/or other product characteristics known in the art. Using the embodiment illustrated in FIG. 3a, the first product identification information may include a product identification code that allows purchasing and sales data for any shoes of the same type, brand, and/or style at the physical location (i.e., that shoe store) to be retrieved, as discussed in further detail below. In other embodiments, the product identification information may be any identifier used at the physical location 300 (i.e., the store selling the products) to monitor, record, track, and/or otherwise document inventors, sales, and/or other information about products for sale. While a few examples of the retrieval of product identification information at block 106 of the method 100 using the product information received at block 102 of the method 100 have been provided, one of skill in the art will recognize that other methods for retrieving first product identification information will fall within the scope of the present disclosure. Furthermore, while the first product identification information has been described as an identifier for allowing inventory and sales information to be retrieved, one of skill in the art will recognize that identifiers that allow the retrieval of other product type specific, product brand specific, and/or product style specific information using the first product identification information will fall within the scope of the present disclosure.

The method 100 then proceeds to block 108 where first product purchase history information and other product purchase history information are retrieved using the first product identification information and the location information. As detailed below, the location information received at block 104 may be used to determine a database that is associated with the physical location 300 (i.e., the store selling products), and the first product identification information retrieved at block 106 may be used to search that database for product purchase history information related to the product that the user 304 is interested in purchasing, along with product purchase history information for one or more other products that are “comparable” to the product that the user 304 is interested in purchasing. As also detailed below, comparable products may be products that are similar types of products, similar brands of products, similar styles of products, similar cost products, and/or include a variety of other product characteristics known in the art. Furthermore, while not illustrated, the user 304 may define which product characteristics should be used, how product characteristics should be weighted, and/or a variety of other criteria in order to define how comparable products are retrieved.

As discussed above, at block 108, the location information received in block 104 may be used to determine a location database that is associated with the physical location 300. In an embodiment, the location database may be located in the user device 200, located in a merchant device that is located at the physical location 300 and coupled to the user device 200 over a network (e.g., the Internet, a LAN, etc.), coupled to the user device 200 over a network, coupled to the merchant device over a network, and/or accessible by the user device 200 in a variety of other manners known in the art. The first product identification information may then be used by the user device 200 to search the location database for product purchase history information, or provided by the user device 200 to a product purchase history device that searches the location database for product purchase history information.

The location database includes product purchase histories for some or all of the products (e.g., products 302a, 302b, 302c, 302d, etc.) at the physical location 300. In an embodiment, the first product identification information identifies the product that the user 304 is interested in purchasing, and allows for the retrieval of the first product purchase history information of that product. In addition, the first product identification information either includes or allows for the retrieval of information about a type of the product that the user 304 is interested in purchasing, a brand of that product, a style of that product, a cost of that product, and/or a variety of other product details known in the art. Using the product details of the product that the user 304 is interested in purchasing, one or more other products that are “comparable” to the product that the user 304 is interested in purchasing may be determined, and the purchase history information for that other comparable product (or those other comparable products) may be retrieved.

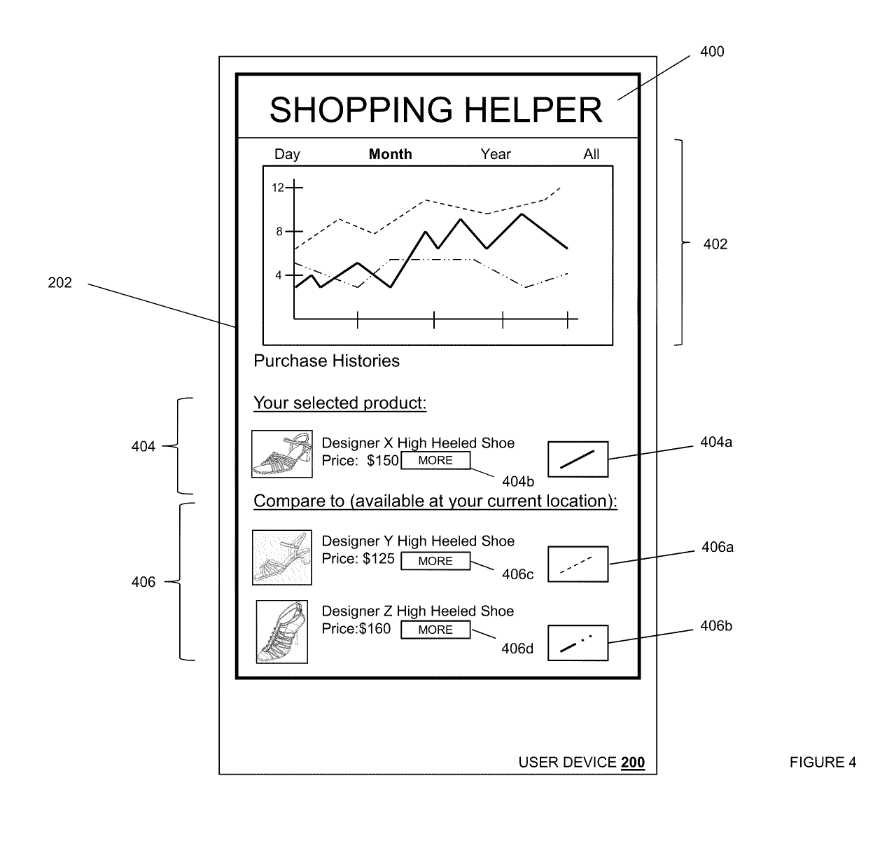

Referring now to FIGS. 1 and 4, the method then proceeds to block 110 where the first product purchase history information and the other product purchase history information is provided for display. In an embodiment, the first product purchase history information and the other product purchase history information is provided for display on the display device 202 of the user device 200 by the product comparison application as a product comparison screen 400, illustrated in FIG. 4. The product comparison screen 400 includes a graphical comparison section 402, a selected product section 404, and a comparable product section 406. In the illustrated embodiment, the selected product section 404 includes an image of the selected product, a brand of the selected product (“Designer X”), a type of the selected product (“high heeled shoe”), and a cost of the selected product (“$150”), along with a graphical identifier 404a for the selected product. Similarly, in the illustrated embodiment, the comparable product section 406 includes two other products that are “comparable” to the selected product, and for each of the other products, an image of the other product, a brand of the other products (“Designer Y”, Designer “Z”), a type of the of the other products (“high heeled shoe”), and a cost of the other products (“$125”, $160), along with respective graphical identifiers 406a and 406b for the other products, are displayed.

As discussed above, the user 304 may define the criteria for a comparable product (e.g., prior to the method 100, during the method 100, etc.) For example, in the embodiment illustrated in FIG. 4, the user 304 may have defined comparable products to be the same type and style of the selected product, within a price range of the price of the selected product, and being a different brand than the selected product.

Furthermore, in the illustrated embodiment, the graphical comparison section 402 displays each of the graphical identifiers 404a, 406a, and 406 according to the first product purchase history information and the other product purchase history information retrieved in block 108 of the method 100. As discussed above, the product purchase history information retrieved at block 108 of the method 100 may include a variety of inventory and/or sales information associated with the product that the user 304 is interested in purchasing, or associated with the products that are comparable to that product, and the graphical comparison section 402 may be used to display that purchase history information graphically. In the illustrated embodiment, the first product purchase history information associated with the product that the user 304 is interested in purchasing is displayed using the graphical identifier 404a, second product purchase history information that is associated with a second product that is comparable to the product the user is interested in purchasing is displayed using the graphical identifier 406a, and third product purchase history information that is associated with a third product that is comparable to the product the user is interested in purchasing is displayed using the graphical identifier 406b. In the illustrated embodiment, each of the first, second, a third product purchase history information provides respective inventory and/or sales information about its respective product over the previous month. However, as can be seen, product purchase history information for products may be displayed and/or compared by day, year, using all available data, and/or using other time periods, and/or using other purchase/sales data sorting criteria known in the art.

The method 100 may then proceed to optional block 112 where additional first product information and additional other product information is retrieved and displayed. For example, the selected product section 404 and the comparable product section 406 on the product comparison screen 400 also include respective selectors 404b, 406c, and 406d associated with the product the user is interested in purchasing and with each of the other products, respectively, that are comparable to the product the user is interested in purchasing. In an embodiment, the use 304 may select any of the selectors 404b, 406c, and 406d in order to retrieve and display additional information about its respective product.

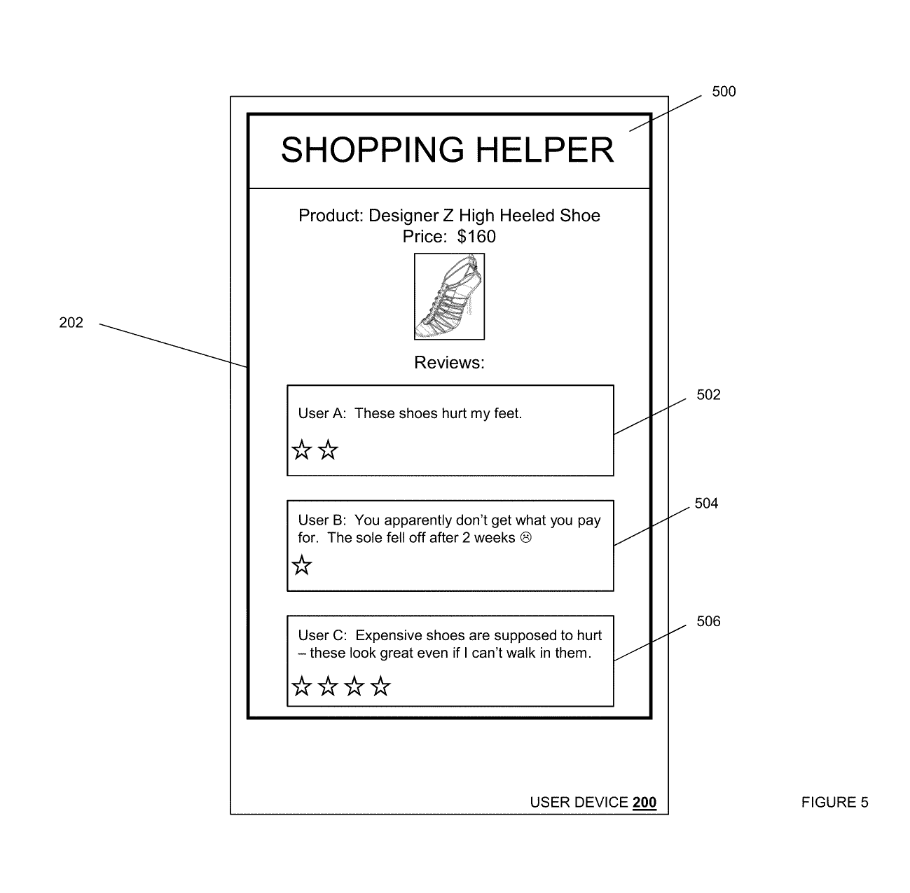

Referring now to FIG. 5, an embodiment of a product review screen 500 is illustrated. In an embodiment, the additional product information displayed on the product review screen 500 may be retrieved and displayed on the display device 202 following the user 304 selecting one of the selectors 404b, 406c, and 406d. For example, the user device 200 may use product identification information associated with a product that is associated with the selected selector 404b, 406c, or 406d to retrieve, over a network, product review information associated with that product. In the illustrated embodiment, the additional product information that includes review information on the product review screen 500 has been retrieved over a network and displayed on the display device 202 in response to the user selecting the selector 406d associated with the “Designer Z High Heeled Shoe”. The product review screen 500 includes a plurality of reviews 502, 504, and 506 retrieved from a review database over a network that are related to the “Designer Z High Heeled Shoe” product. While additional product information has been illustrated an described as reviews for a selected product, additional product information associated with a product may include reviews of the store selling the product, news articles discussing the product, and/or a variety of other information related to the product and/or store or merchant (e.g., at the physical location 300) known in the art.

Thus, a system and method for providing product comparisons has been described that allows a user at a physical location to compare a product for sale at that physical location to other products available for purchase at that physical location to determine which product to purchase. In the embodiment illustrated above, one of skill in the art will recognize that a user may find purchase histories for a product valuable in determining whether to purchase that product, and the comparison of purchase histories of comparable products may allow the user to determine which of a plurality of products to purchase. The systems and methods provide such local product comparisons (e.g., a comparison of products available locally in a physical location/store) by determining information about a product the user is interested in purchasing, determining a location of the user and product, retrieving purchase history information about that product using the information about that product, and retrieving purchase history information about other products available in the physical location so that the purchase histories of a plurality of products may be displayed to the user to assist the user in selecting one of those products for purchase. A few examples of specific products purchased using the systems and methods of the present disclosure will now be discussed below, these examples are not meant to be limiting, as one of skill in the art will recognize the wide variety of products that will benefit from the systems and methods of the present disclosure.

In one example, a user may wish to purchase a bottle of wine. A wine store or other merchant selling alcoholic beverages at a physical location may provide for purchase hundreds of different types and brands of wine such that the user walking into the store may be overwhelmed. However, the user may know that they wish to purchase a certain type of wine (e.g., a merlot) at around a particular price (e.g., approximately $20.) The user may then find a $20 bottle of merlot and use their user device to capture an image of the label or the UPC, scan the UPC, or type or speak the name of the wine into the user device. The user device will then determine the type and brand of the bottle of wine, determine the location of the store, and access a database to retrieve a purchase and/or sales history of that type of wine at that store, along with a purchase and/or sales history of one or more other brands of that type of wine that are near the same cost (e.g., $15-$25) at that store. The purchase and/or sales histories of each of brands of that type of wine and in that cost range will then be comparatively displayed to help a user in determining which of the bottles of wine to buy. For example, given three brands of the same type of wine at similar cost, the user may wish to purchase the wine that is selling best that month. Furthermore, the user may refine their decision by reviewing reviews of the different brands of wine.

In another example, a user may wish to purchase a loaf of bread. A grocery store or other merchant selling food at a physical location may provide for purchase dozens of different types and brands of bread such that the user walking into the store may be overwhelmed. However, the user may know that they wish to purchase a certain brand of bread at around a particular price (e.g., approximately $5.) The user may then find a $5 loaf of bread from a particular brand and use their user device to capture an image of the label or the UPC, scan the UPC, or type or speak identifying information about the bread into the user device. The user device will then determine the type and brand of the loaf of bread, determine the location of the store, and access a database to retrieve a purchase and/or sales history of that brand and type of bread at that store, along with a purchase and/or sales histories of one or more other types of bread from that brand near the same cost (e.g., $3-$7) at that store. The purchase and/or sales histories of each of loafs of bread will then be comparatively displayed to help a user in determining which of the loafs to buy. For example, given three types of the same brand of bread at similar cost, the user may wish to purchase the bread that is selling best that month. Furthermore, the user may refine their decision be reviewing reviews of the store at that physical location to determine whether to buy the bread there (e.g., the store may have refused to accept a return of a loaf of bread that was spoiled when purchase, which might influence the user to buy their bread elsewhere.)

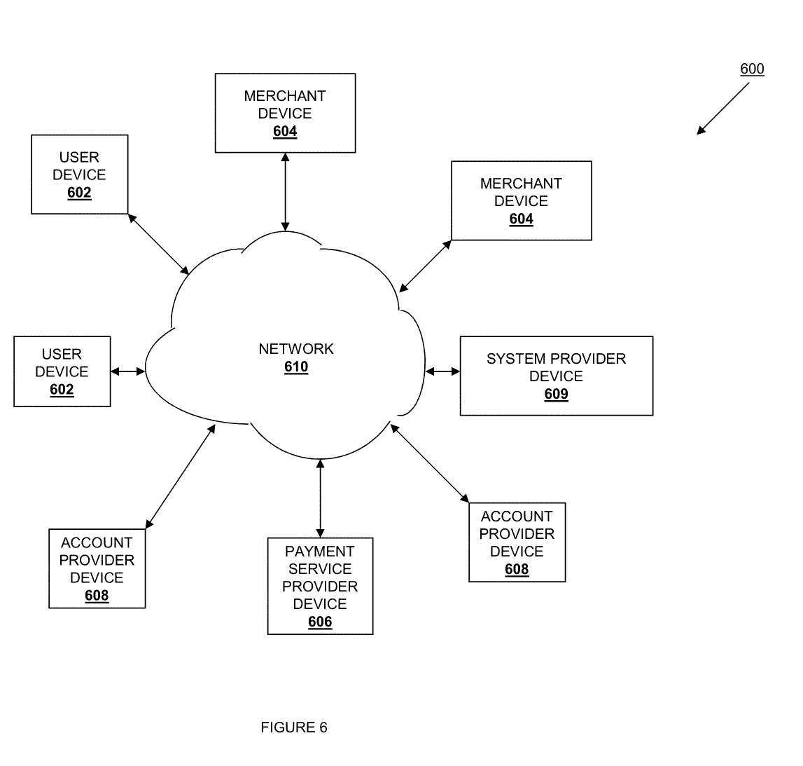

Referring now to FIG. 6, an embodiment of a network-based system 600 for implementing one or more processes described herein is illustrated. As shown, network-based system 600 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 6 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 600 illustrated in FIG. 6 includes a plurality of user devices 602, a plurality of merchant devices 604, a payment service provider device 606, a plurality of account holder devices 608, and/or a system provider device 609 in communication over a network 610. Any of the user devices 602 may be the user device 200, discussed above. The merchant devices 604 may be the merchant devices discussed above and may be operated by the merchants discussed above. The payment service provider device 606 may be the payment service provider devices discussed above and may be operated by a payment service provider such as, for example, PayPal Inc. of San Jose, Calif. The account provider devices 608 may be the account provider devices discussed above and may be operated by the account providers discussed above such as, for example, credit card account providers, bank account providers, savings account providers, and a variety of other account providers known in the art. The system provider device 609 may be any other device that assists in providing the systems and methods discussed above (e.g., providing databases and engines for performing the functions discussed above.)

The user devices 602, merchant devices 604, payment service provider device 606, account provider devices 608, and/or system provider device 609 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 600, and/or accessible over the network 610.

The network 610 may be implemented as a single network or a combination of multiple networks. For example, in various embodiments, the network 610 may include the Internet and/or one or more intranets, landline networks, wireless networks, and/or other appropriate types of networks.

The user device 602 may be implemented using any appropriate combination of hardware and/or software configured for wired and/or wireless communication over network 610. For example, in one embodiment, the user device 602 may be implemented as a personal computer of a user in communication with the Internet. In other embodiments, the user device 602 may be a smart phone, personal digital assistant (PDA), laptop computer, and/or other types of computing devices.

The user device 602 may include one or more browser applications which may be used, for example, to provide a convenient interface to permit the payer to browse information available over the network 610. For example, in one embodiment, the browser application may be implemented as a web browser configured to view information available over the Internet.

The user device 602 may also include one or more toolbar applications which may be used, for example, to provide user-side processing for performing desired tasks in response to operations selected by the user. In one embodiment, the toolbar application may display a user interface in connection with the browser application.

The user device 602 may further include other applications as may be desired in particular embodiments to provide desired features to the user device 602. In particular, the other applications may include a payment application for payments assisted by a payment service provider through the payment service provider device 606. The other applications may also include security applications for implementing user-side security features, programmatic user applications for interfacing with appropriate application programming interfaces (APIs) over the network 610, or other types of applications. Email and/or text applications may also be included, which allow the user to send and receive emails and/or text messages through the network 610. The user device 602 includes one or more user and/or device identifiers which may be implemented, for example, as operating system registry entries, cookies associated with the browser application, identifiers associated with hardware of the user device 602, or other appropriate identifiers, such as a phone number. In one embodiment, the user identifier may be used by the merchant device 604, payment service provider device 606, the account provider device 608, and/or the system provider device 609 to associate the user with a particular account as further described herein.

The merchant device 604 may be maintained, for example, by a conventional or on-line merchant, conventional or digital goods seller, individual seller, and/or application developer offering various products and/or services in exchange for payment to be received conventionally or over the network 610. In this regard, the merchant device 604 may include a database identifying available products and/or services (e.g., collectively referred to as items) which may be made available for viewing and purchase by the user.

The merchant device 604 also includes a checkout application which may be configured to facilitate the purchase by the payer of items. The checkout application may be configured to accept payment information from the user through the user device 602, the account provider through the account provider device 608, and/or from the payment service provider through the payment service provider device 606 over the network 610.

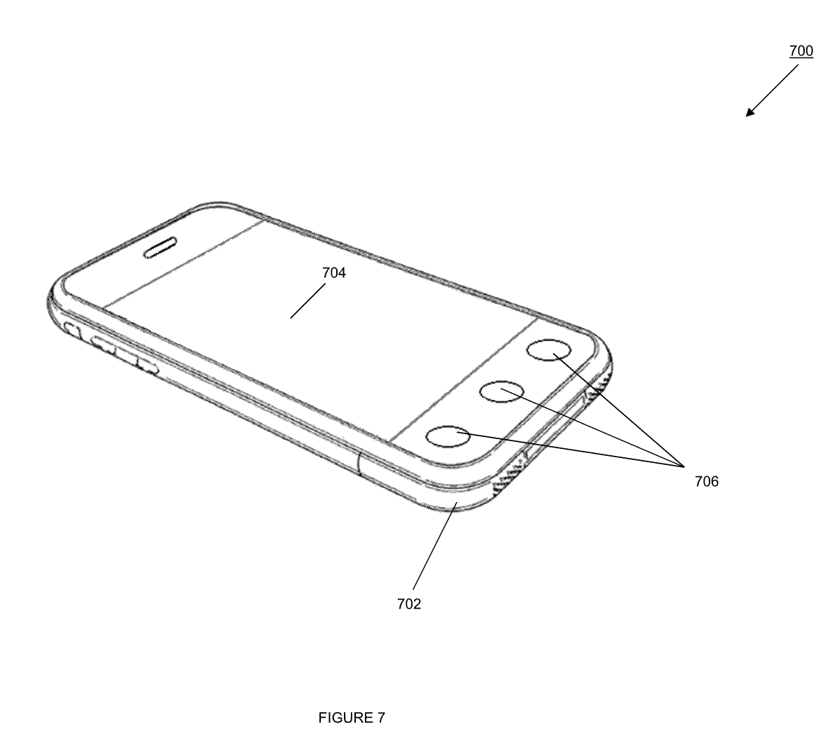

Referring now to FIG. 7, an embodiment of a user device 700 is illustrated. The user device 700 may be the user devices 200 and/or 602. The user device 700 includes a chassis 702 having a display 704 and an input device including the display 704 and a plurality of input buttons 706. One of skill in the art will recognize that the user device 700 is a portable or mobile phone including a touch screen input device and a plurality of input buttons that allow the functionality discussed above with reference to the method 100. However, a variety of other portable/mobile user devices may be used in the method 100 without departing from the scope of the present disclosure.

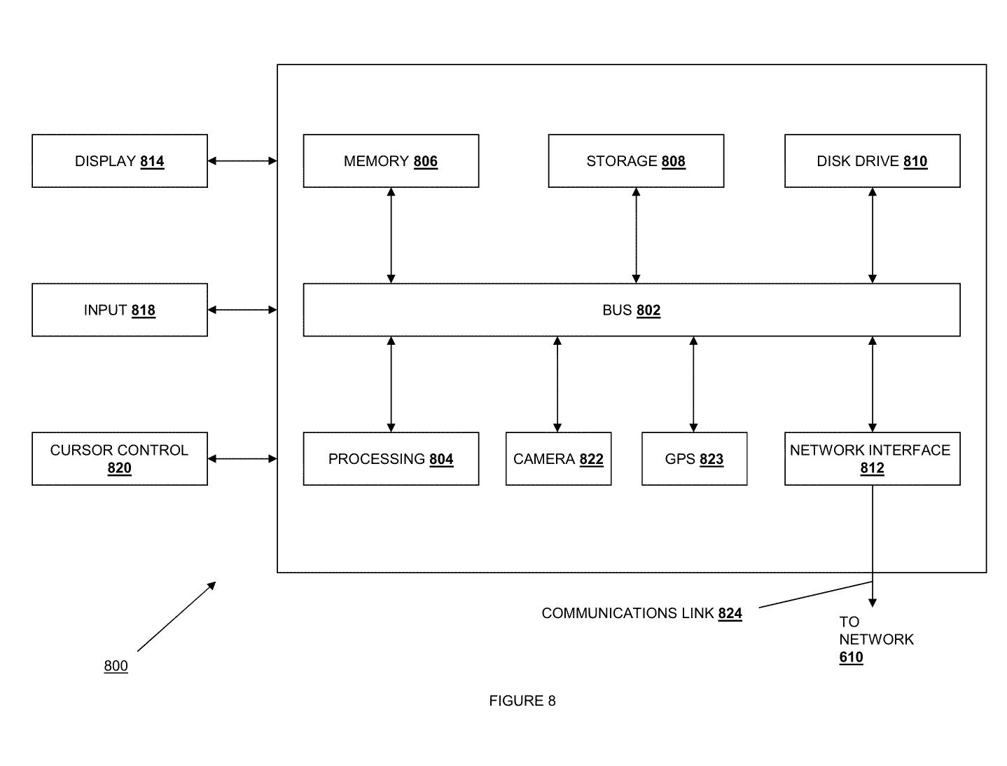

Referring now to FIG. 8, an embodiment of a computer system 800 suitable for implementing, for example, the user device 200, the user device 602, the user device 700, the merchant device 604, the payment service provider device 606, the account provider device 608, and/or the system provider device 609 is illustrated. It should be appreciated that other devices utilized by users, merchants, payment service providers, account providers, and/or system providers in the payment system discussed above may be implemented as the computer system 800 in a manner as follows.

In accordance with various embodiments of the present disclosure, computer system 800, such as a computer and/or a network server, includes a bus 802 or other communication mechanism for communicating information, which interconnects subsystems and components, such as a processing component 804 (e.g., processor, micro-controller, digital signal processor (DSP), etc.), a system memory component 806 (e.g., RAM), a static storage component 808 (e.g., ROM), a disk drive component 810 (e.g., magnetic or optical), a network interface component 812 (e.g., modem or Ethernet card), a display component 814 (e.g., CRT or LCD), an input component 818 (e.g., keyboard, keypad, or virtual keyboard), a cursor control component 820 (e.g., mouse, pointer, or trackball), a camera 822 or other image capturing device, and/or a location determination component 823 (e.g., a Global Positioning System (GPS) device as illustrated, a cell tower triangulation device, and/or a variety of other location determination devices known in the art.) In one implementation, the disk drive component 810 may comprise a database having one or more disk drive components.

In accordance with embodiments of the present disclosure, the computer system 800 performs specific operations by the processor 804 executing one or more sequences of instructions contained in the memory component 806, such as described herein with respect to the user device 200, 602, and 700, the merchants device(s) 604, the payment service provider device 606, the account provider device(s) 608, and/or the system provider device 609. Such instructions may be read into the system memory component 806 from another computer readable medium, such as the static storage component 808 or the disk drive component 810. In other embodiments, hard-wired circuitry may be used in place of or in combination with software instructions to implement the present disclosure.

Logic may be encoded in a computer readable medium, which may refer to any medium that participates in providing instructions to the processor 804 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 810, volatile media includes dynamic memory, such as the system memory component 806, and transmission media includes coaxial cables, copper wire, and fiber optics, including wires that comprise the bus 802. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 800. In various other embodiments of the present disclosure, a plurality of the computer systems 800 coupled by a communication link 824 to the network 610 (e.g., such as a LAN, WLAN, PTSN, and/or various other wired or wireless networks, including telecommunications, mobile, and cellular phone networks) may perform instruction sequences to practice the present disclosure in coordination with one another.

The computer system 800 may transmit and receive messages, data, information and instructions, including one or more programs (i.e., application code) through the communication link 824 and the network interface component 812. The network interface component 812 may include an antenna, either separate or integrated, to enable transmission and reception via the communication link 824. Received program code may be executed by processor 804 as received and/or stored in disk drive component 810 or some other non-volatile storage component for execution.

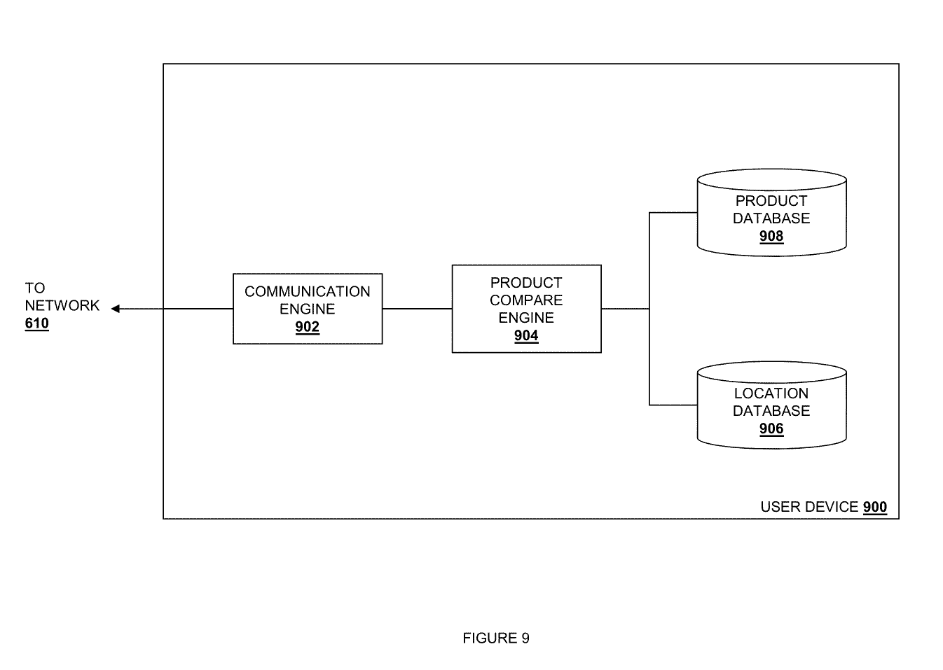

Referring now to FIG. 9, an embodiment of a user device 900 is illustrated. In an embodiment, the user device 900 may be the user device 200, 602, and 700, and/or include components (e.g., engines, databases, etc.) that may be provided instead by the merchant devices 604, the payment service provider device 606, the account holder device 608, and/or the system provider device 609. The user device 900 includes a communication engine 902 that is coupled to the network 610 and to a product compare engine 904 that is coupled to each of a location database 906 and a product database 908. The communication engine 902 may be software or instructions stored on a computer-readable medium that allows the user device 900 to send and receive information over the network 610. The product compare engine 904 may be software or instructions stored on a computer-readable medium that is operable to receive product information, receive location information, retrieve product identification information using the product information and the product database 908, retrieve product purchase histories using the product identification information and the location database, retrieve additional product information, and provide any of the other functionality that is discussed above. While the databases 906 and 908 have been illustrated as located in the user device 900, as discussed above they may be connected to the product compare engine 904 through the network 610 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory;
one or more hardware processors coupled to the memory and operable to read instructions from the memory to perform the steps of:
receiving, from an image capturing device, an image that includes a first product;
receiving, from a location determination device, location information associated with a location of the first product;
retrieving first product identification information using the image, wherein the first product identification information identifies at least a type of the first product;
retrieving, using the first product identification information and the location information, first product purchase history information about the first product and second product purchase history information about a second product that is associated with the location; and
providing, for display on a display device, the first product purchase history information and the second product purchase history information.

2. The system of claim 1, wherein the step of retrieving first product identification information using the image further includes the steps of:
sending the image over a network and, in response, receiving the first product identification information over the network.

3. The system of claim 1, wherein the step of retrieving first product purchase history information about the first product and second product purchase history information about a second product further includes the steps of:
sending the first product identification information and the location information over a network and, in response, receiving the first product purchase history information about the first product and second product purchase history information about the second product over the network.

4. The system of claim 1, wherein the one or more processors are operable to read instructions from the memory to perform the steps of:
retrieving, using the first product identification information and the location information, third product purchase history information about a third product that is associated with the location; and
providing, for display on a display device, the first product purchase history information, the second product purchase history information, and the third product purchase history.

5. The system of claim 1, wherein the first product purchase history and the second product purchase history are provided for display on the display device as a graphical comparison.

6. The system of claim 1, wherein the one or more processors are operable to read instructions from the memory to perform the steps of:
retrieving, using the first product identification information and the location information, first product review information and second product review information; and
providing, for display on the display device, the first product review information and the second product review information.

7. A method, comprising:
receiving, from an image capturing device, an image that includes a first product;
receiving, from a location determination device, location information associated with a location of the first product;
retrieving first product identification information using the image, wherein the first product identification information identifies at least a type of the first product;
retrieving, using the first product identification information and the location information, first product purchase history information about the first product and second product purchase history information about a second product that is associated with the location; and
providing, for display on a display device, the first product purchase history information and the second product purchase history information.

8. The method of claim 7, wherein the retrieving first product identification information using the image further comprises:
sending the image over a network and, in response, receiving the first product identification information over the network.

9. The method of claim 7, wherein the retrieving first product purchase history information about the first product and second product purchase history information about a second product further comprises:
sending the first product identification information and the location information over a network and, in response, receiving the first product purchase history information about the first product and second product purchase history information about the second product over the network.

10. The method of claim 7, further comprising:
retrieving, using the first product identification information and the location information, third product purchase history information about a third product that is associated with the location; and
providing, for display on the display device, the first product purchase history information, the second product purchase history information, and the third product purchase history.

11. The method of claim 7, wherein the first product purchase history and the second product purchase history are provided for display on the display device as a graphical comparison.

12. The method of claim 7, further comprising:
retrieving, using the first product identification information and the location information, first product review information and second product review information; and
providing, for display on the display device, the first product review information and the second product review information.

13. The method of claim 7, wherein the first product purchase history information about the first product and the second product purchase history information about the second product are retrieved from a database that is located at the location.

14. A non-transitory machine-readable medium comprising a plurality of machine-readable instructions which, when executed by one or more processors, are adapted to cause the one or more processors to perform a method comprising:
receiving, from an image capturing device, an image that includes a first product;
receiving, from a location determination device, location information associated with a location of the first product;
retrieving first product identification information using the image, wherein the first product identification information identifies at least a type of the first product;
retrieving, using the first product identification information and the location information, first product purchase history information about the first product and second product purchase history information about a second product that is associated with the location; and
providing, for display on a display device, the first product purchase history information and the second product purchase history information.

15. The non-transitory machine-readable medium of claim 14, wherein the retrieving first product identification information using the image further comprises:
sending the image over a network and, in response, receiving the first product identification information over the network.

16. The non-transitory machine-readable medium of claim 14, wherein the retrieving first product purchase history information about the first product and second product purchase history information about a second product further comprises:
sending the first product identification information and the location information over a network and, in response, receiving the first product purchase history information about the first product and second product purchase history information about the second product over the network.

17. The non-transitory machine-readable medium of claim 14, wherein the method further comprises:
retrieving, using the first product identification information and the location information, third product purchase history information about a third product that is associated with the location; and
providing, for display on the display device, the first product purchase history information, the second product purchase history information, and the third product purchase history.

18. The non-transitory machine-readable medium of claim 14, wherein the first product purchase history and the second product purchase history are provided for display on the display device as a graphical comparison.

19. The non-transitory machine-readable medium of claim 14, wherein the method further comprises:
retrieving, using the first product identification information and the location information, first product review information and second product review information; and
providing, for display on the display device, the first product review information and the second product review information.

20. The non-transitory machine-readable medium of claim 14, wherein the first product purchase history information about the first product and the second product purchase history information about the second product are retrieved from a database that is located at the location.
